(19) United States
(12) Patent Application Publication
(10) Pub. No.: US 2010/0332660 A1
(43) Pub. Date: Dec. 30, 2010

(54) ADAPTIVE RESOURCE ALLOCATION FOR PARALLEL EXECUTION OF A RANGE QUERY

(75) Inventors: Rodrigo FONSECA, Albany, CA (US); Brian Frank COOPER, San Jose, CA (US); Adam SILBERSTEIN, Sunnyvale, CA (US); Ymir VIGFUSSON, Ithaca, NY (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/495,550

(22) Filed: Jun. 30, 2009

(51) Int. Cl. G06F 15/173; G06F 15/177

(52) U.S. Cl. 709/226; 709/222; 709/224

(57) ABSTRACT

A method of allocating servers for range requests includes receiving a range request for items in a database that is distributed across storage devices that are accessible through corresponding servers in a network that includes the storage devices and the servers; and initializing a server-allocation value for the range request, where the server-allocation value specifies a number of servers to allocate for executing the range request. The method further includes executing the range request by allocating the servers and using the allocated servers to provide values from the range request to a client that accesses the network; and updating the server-allocation value while executing the range request to improve a consumption rate for the client by comparing changes in the consumption rate with changes in the number of allocated servers.

### BACKGROUND OF THE INVENTION

1. Field of Invention

The present invention relates to data systems generally and more particularly to retrieving data from a distributed database using a range query.

2. Description of Related Art

In a data store, a range query is a common and frequently executed operation. A dataset or data collection has a plurality of records, each record having a key field, such that the values of the key field may be sequentially arranged. A range query retrieves the records for which the value of the key field is within a range specified by the range query.

For example, an e-commerce table may contain records of items for sale. A record key may be the time at which the item was inserted (concatenated with some unique identifier, such as item id). Another field in each record is a category, such as electronics or housewares. Users pose queries over the database such as “select all items posted in the last 24 hours.” A query may also contain a selection predicate, such as “select all items posted in the last 24 hours where category=car.” In another example, a table contains record that correspond to web addresses. One non-key field of the records may be “click count,” corresponding to the number of times the page has been visited. There may be an index over the table, where the index key is “click count,” concatenated with the original key. Users pose queries such as “select all pages with click counts greater than 1000.”

In a conventional database, executing a range query is straightforward. Given a set of records sorted by the attribute to be ranged over, the database engine seeks on the disk to the first record falling within the range, and scans sequentially forward through all records in the range. If records are not sorted by the range attribute, a solution is to build an index over the attribute, and scan over the index. Sequential scan is a very efficient way to read records off disk; in the standard single disk setting, it is a very good solution.

However, the increasing size and complexity of databases has led to distributed systems that allow parallel access of storage devices through corresponding servers. See, for example, “PNUTS: Yahoo!'s hosted data serving platform,” by B. F. Cooper et al., Proc. 34th VLDB, pages 1277-1288, August 2008. Conventional methods for executing range queries have not, in general, enabled improved performance in this context.

Thus there is a need for improved systems and methods for retrieving data from a distributed database using a range query.

### SUMMARY OF THE INVENTION

In one embodiment of the present invention, a method of allocating servers for range requests includes receiving a range request for items in a database that is distributed across storage devices that are accessible through corresponding servers in a network that includes the storage devices and the servers; and initializing a server-allocation value for the range request, where the server-allocation value specifies a number of servers to allocate for executing the range request. The method further includes executing the range request by allocating the servers and using the allocated servers to provide values from the range request to a client that accesses the network; and updating the server-allocation value while executing the range request to improve a consumption rate for the client by comparing changes in the consumption rate with changes in the number of allocated servers.

One or more values from the range request can be saved in a computer-readable medium. For example, values can be saved directly or through some related characterization in memory (e.g., RAM (Random Access Memory)) or permanent storage (e.g., a hard-disk system).

According to one aspect of this embodiment, the range request may correspond to a sequence defined by an index, and the method may further includes partitioning the sequence for the range request into sub-sequences for corresponding storage devices where separate portions of the sequence are stored.

According to another aspect, initializing the server-allocation value may include assigning a first value for the server-allocation value, and, after assigning the first value, increasing the server-allocation value while measuring the consumption rate until a termination condition for initializing the server-allocation value is reached, where the termination condition for initializing the server-allocation value includes a non-increasing consumption rate.

According to another aspect, allocating the servers may include allocating an additional server when the server-allocation value is increased or when the server-allocation value is maintained and a given server reaches a termination condition for providing range-request values from a given storage device to the client.

According to another aspect, wherein allocating the servers may include allocating no additional server when the server-allocation value is decreased and a given server reaches a termination condition for providing range-request values from a given storage device to the client.

According to another aspect, updating the server-allocation value may include increasing the server-allocation value while measuring the consumption rate until a termination condition for increasing the server-allocation value is reached, where the termination condition for increasing the server-allocation value includes a non-increasing consumption rate.

According to another aspect, updating the server-allocation value may include decreasing the server-allocation value while measuring the consumption rate until a termination condition for decreasing the server-allocation value is reached, where the termination condition for decreasing the server-allocation value includes a decreasing consumption rate.

According to another aspect, updating the server-allocation value may include randomizing a choice for increasing, decreasing, or maintaining the server-allocation value. And then increasing the server-allocation value may include increasing the server-allocation value while measuring the consumption rate until a termination condition for increasing the server-allocation value is reached, where the termination condition for increasing the server-allocation value includes a non-increasing consumption rate. And then decreasing the server-allocation value may include decreasing the server-allocation value while measuring the consumption rate until a termination condition for decreasing the server-allocation value is reached, where the termination condition for decreasing the server-allocation value includes a decreasing consumption rate.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer.

In these ways the present invention enables improved systems and methods for retrieving data from a distributed database using a range query.

### BRIEF DESCRIPTION OF THE DRAWINGS

FIG. 1 shows a system that executes range requests for an embodiment of the present invention.

FIG. 2 shows a method for allocating servers for range requests for an embodiment of the present invention.

FIGS. 3A, 3B, and 3C show specific embodiments related to the embodiment of FIG. 2.

FIG. 4 shows a system that executes range queries for another embodiment of the present invention.

FIG. 5 shows a method for executing range requests for the embodiment shown in FIG. 4.

FIG. 6 shows further detail for the embodiment shown in FIG. 4.

FIG. 7 shows a conventional general-purpose computer.

FIG. 8 shows a conventional Internet network configuration.

### DETAILED DESCRIPTION OF EXEMPLARY EMBODIMENTS

In a system having a plurality of storage devices, a dataset or data collection may be divided into a plurality of tables or tablets. The data records within each tablet have a key field, such that the values of the key field may be sequentially arranged. The tablets may be stored in a plurality of storage devices, and a given storage device may contain one or more of the tablets. In the case of a storage device having multiple tablets, the tablets may correspond to continuous ranges of data, or non-contiguous ranges. Systems and methods described herein address the problem of executing range queries (or range requests) over a horizontally partitioned and distributed table. The table is broken into many partitions, with each partition holding a contiguous sub-range of the entire table. In some operational settings, the system includes a plurality of storage servers, each of which stores one or more partitions. Although a partition itself contains a contiguous range of records, the different partitions stored in a single storage device or on plural storage devices accessible by a single storage server may be from totally disparate parts of the overall range.

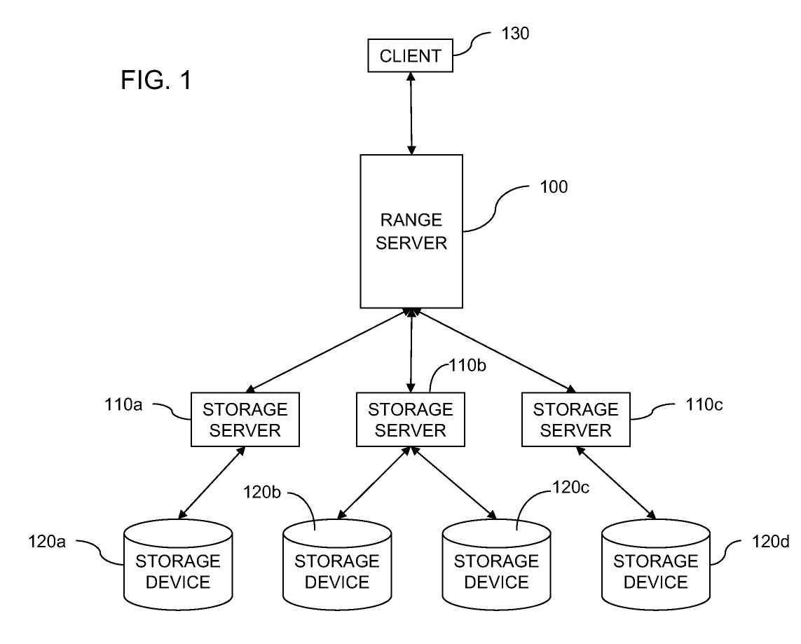

FIG. 1 shows a range server 100 that is adapted to receive and handle range queries from a client 130. The range server 100 is coupled to a plurality of storage servers 110a-110c. The storage servers 110a-110c have access to a plurality of storage devices 120a-120d, each storing at least one tablet of the database. Although an example is shown with three storage servers 110a-110c and four storage devices 120a-120d, the system and method may include any number of storage servers and any number of storage devices.

In one optional method of using this system for processing range queries, the range server 100 handles range queries that enter the system. Range server 100 holds a partition map (not shown), which stores the mapping of each horizontal partition to the storage servers 110a-110c on which it resides. Given a range query from the client 130, the range server 100 breaks the query range into sub-ranges along partition boundaries and queries each partition in turn sequentially, while passing results back to the client 130.

The sequential solution described above under-utilizes the potential of the architecture shown in FIG. 1. For a query spanning multiple partitions 120a-120d, if those partitions are accessible by multiple storage servers 110a-110c, partitions can be queried in parallel, and more quickly return results to the client 130.

As mentioned above, a range server 100 handles parallelizing range queries. For a given query, the range server 100 first breaks the range query into sub-ranges along partition boundaries. The following example involves a query for which response includes the end (but not the beginning) of the first partition and the beginning (but not the end) of the second portion. In this example, if the query range is (banana:melon) and partition boundaries are [apple:grape],[grape:pear], the range server 100 breaks the query into (banana:grape) and (grape:melon). Then the range server 100 issues the sub-queries to their respective storage servers 110a-110c. It may choose to issue the queries sequentially, entirely in parallel, or use a combination of sequential and parallel queries. The range server 100 collects results streaming back from the storage servers 110a-110c, and forwards them on the client 130.

Range query performance for the range server 100 can be measured in a number of ways. One rate is aggregate storage server delivery rate, which is the average number of total bytes/unit of time delivered from all storage servers 110a-110c to the range server 100. Another rate is client consumption rate (or uptake rate), the average number of bytes/unit of time the client 130 retrieves from the range server 100. Several factors may affect each of these rates. Aggregate storage server delivery rate is mainly affected by the current level of parallelism (number of servers currently returning results) and query selectivity—a query with a very selective predicate may have servers scanning a large number of records but only returning a few to the range server. The client consumption rate is affected by the speed and/or buffering capacity of the client 130, other tasks being performed by the client 130, etc.

Flow control and scheduling influence the degree of parallelism with which a query is processed. In addition, if a client 130 wants results to arrive in a particular order, this may also limit the possible parallelism. In some operational settings, the degree of parallelism can be identified with the number of servers currently allocated for executing the range request. For each query, the range server 100 attempts to execute the range request allocating servers in a way that optimizes data handling, for example, by maximizing the client consumption rate.

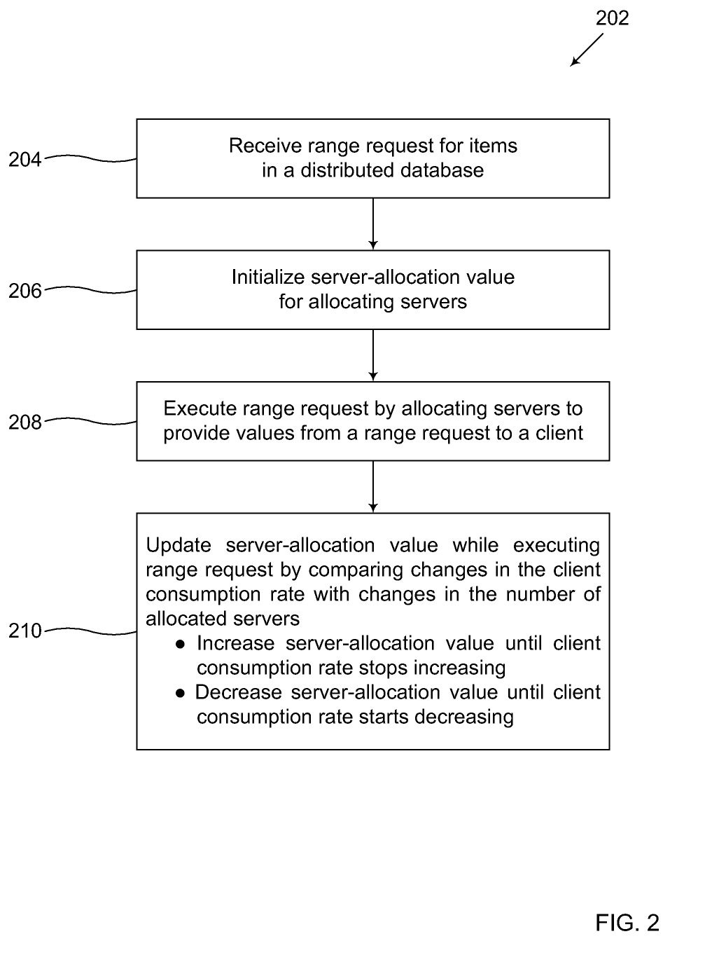

FIG. 2 shows a method 202 of allocating servers for range requests according to an embodiment of the present invention, where operations may be carried out, for example, at the range server 100. First, a range request is received for items in a database that is distributed across storage devices 204. These storage devices are accessible through corresponding servers in a network that includes the storage devices and the servers. Typically, this range request corresponds to a sequence defined by an index (e.g., a key field), and this index can be used to partition the sequence into sub-sequences for corresponding storage devices where separate portions of the sequence are stored. Next a server-allocation value, which is used to specify the number of servers to allocate for executing the range request, is initialized 206. For example, the server-allocation value can be increased from some starting value (e.g., 1) until a corresponding number of servers have been allocated and the client consumption rate stops increasing. Next the range request is executed by allocating the servers and using the allocated servers to provide values from the range request to a client that accesses the network 208.

As an adaptive process, the server-allocation value is updated while executing the range request by comparing changes in the client consumption rate with changes in the number of allocated servers 210. This may include randomizing a choice for increasing, decreasing or maintaining the server-allocation value. Then, the server-allocation value can be increased until the client consumption rate stops increasing, after which the last increase can be reversed since this allocation did not improve performance as measured by the client consumption rate. Similarly, the server-allocation value can be decreased until the client consumption rate starts decreasing, after which the last decrease can be reversed since this de-allocation worsened performance as measured by the client consumption rate. Typically the server-allocation value is changed in unitary increments (e.g., +1, −1). However, in an operational setting with a relatively large number of servers (e.g., 100+), non-unitary increments may be desirable. In some cases, it may be desirable to begin with a larger increment size and then adjust to a smaller increment size so that the server-allocation value changes more slowly as the process continues. Further, in some operational settings embodiments may include multiplicative as well as additive increments.

In addition to random changes in the server-allocation value, non-random changes can also be made. However, the client consumption rate may change for a fixed number of allocated servers for a variety of reasons including the changing complexity of the range request, fluctuations in network traffic, and the performance of additional tasks at the client or at one of the allocated servers. In the case where the client consumption rate decreases due to additional tasks at the client, decreasing the server-allocation value can free up resources for range queries from other clients when the capacity of the subject client is already saturated. In the case where the client consumption rate decreases due to computational burden of the range request, increasing the server-allocation value can improve the client consumption rate when the client has additional capacity. Randomizing changes in the server-allocation value enables the system to adapt to changes in the client consumption rate without additional information on the underlying causes.

When the server-allocation value increases, another server can be allocated for executing the request. After a server finishes providing values to the client from a corresponding storage device, another server can then be allocated in the case where the server-allocation value has not changed; however, in the case where the server-allocation value has decreased, no additional server is allocated. In general, it is preferable to wait for an allocated server to complete its task rather than interrupt its operation when the server-allocation value has changed.

Generally, increases in the server-allocation value are limited so that so that it does not exceed a number of partitions that can be accessed in parallel by storage servers 110a-110c. This limit may be the number of storage servers. If one or more of the storage servers are capable of accessing plural partitions simultaneously (e.g., a RAID system with multiple read heads), then the limit may be set to the number of partitions that can be accessed in parallel, which would be a greater number than the number of storage servers 110a-110c.

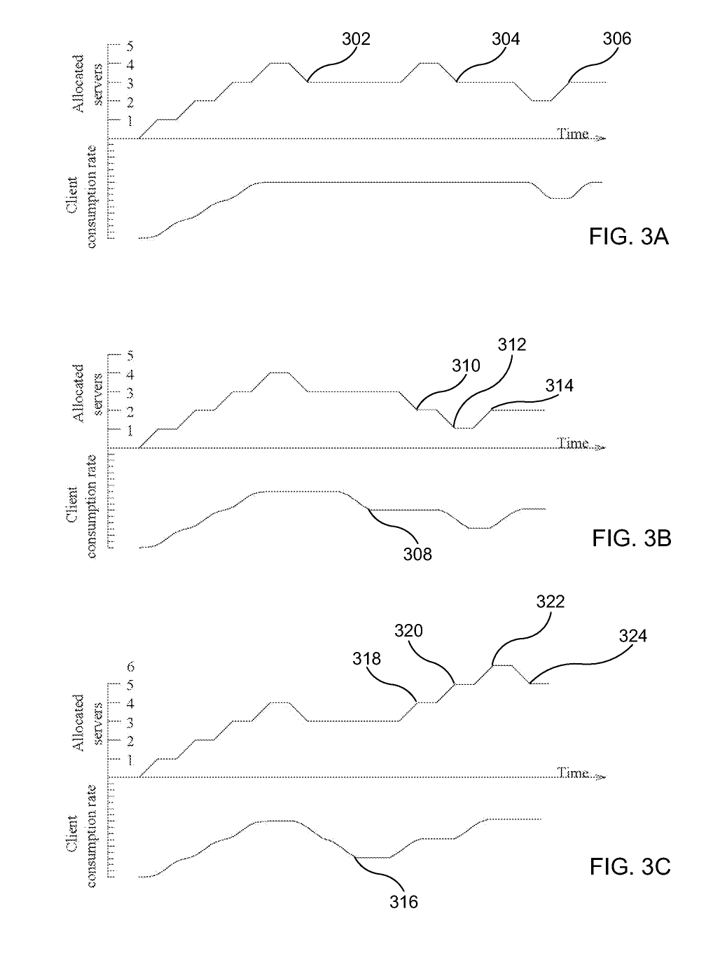

Randomizing a choice for increasing, decreasing or maintaining the server-allocation value can be done for convenience at uniform time increments. For example, at each increment cycle (e.g., some designated time interval) a randomized choice for increasing, decreasing or maintaining the server-allocation value can be made by allocating a probability of ⅓ to each of the three options (e.g., with a conventional random-number generator). FIGS. 3A-3C show characteristic time histories for allocated servers and client consumption rates. Possible time lags between changes in the server-allocation value and changes in the number of allocated servers have been ignored. In FIG. 3A, the number of allocated servers is first set to one and is then incremented by one at each time interval until the client consumption rate stops increasing, after which the last increase is reversed 302. A random increase in the number of allocated servers is reversed after the client consumption rate does not change 304. A random decrease in the number of allocated servers is reversed after the client consumption rate does not change 306. In FIG. 3B the client consumption rate drops 308 (e.g., due to other tasks at the client). Then, the number of allocated servers is randomly decreased a first time 310. Since the client consumption rate does not decrease, the number of allocated servers is decreased a second time 312. However, since this results in a drop in the client consumption rate, the second decrease is reversed 314. In FIG. 3C the client consumption rate drops due to the nature of the range query 316, where an increased computational burden at the server slows the server's delivery rate. For example, the server may reach a part of the range where the ratio of results returned to results scanned decreases so that the server must scan more data to return the same number of results, thereby lowering the delivery rate. Then, the number of allocated servers is randomly increased a first time 318. Since the client consumption rate increases, the number of allocated servers is increased a second time 320. Then, since the client consumption rate again increases, the number of allocated servers is increased a third time 322. However, since the client consumption rate does not increase, the third increase is reversed 324. Depending on the requirements of the operational setting, non-uniform time increments or probabilities can also be used.

In general, these adaptive changes to the server-allocation value are made at time increments that are sufficiently long so that the current server-allocation value has become effective (e.g., the server-allocation value equals the number of allocated servers) and the resulting client consumption rate has been accurately measured (e.g., to average out noise and transitional effects). On the other hand, unnecessarily long times between adaptive changes results in a less adaptive system.

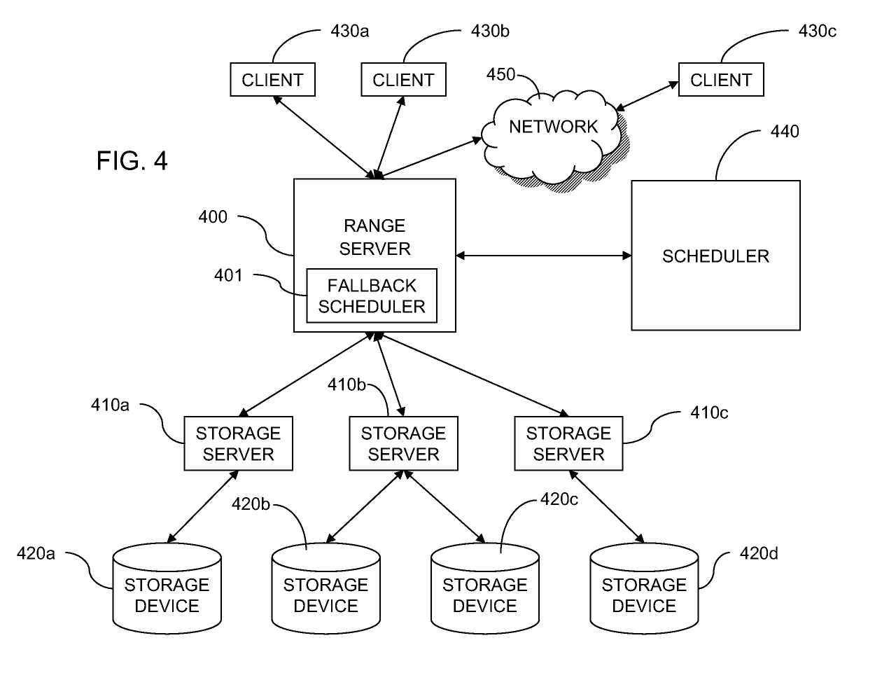

The example of FIG. 1 shows a range server 100 handling one query at a time. However, the operational setting for the above-described method 202 may include multiple clients with competing range queries. FIG. 4 shows a system that includes a range server 400 that processes multiple queries arriving from different clients 430a-430c any of which may be co-located with range server 400 or located remotely and in communication via a network 450, which may be a local area network (LAN), a wide area network (WAN) or the Internet. The range server 400 is coupled to storage servers 410a-410c, and to a scheduler 440. The storage servers 410a-410c have access to storage devices 420a-420d, each storing at least one tablet (or portion) of the database. Although an example is shown with three storage servers 410a-410c and four storage devices 420a-420d, the system and method may include any number of storage servers and any number of storage devices.

The queries contend for the same set of storage servers 410a-410c that access storage devices 420a-420d, so a scheduler 440 is provided to ensure that the queries are processed in some kind of fair manner. The scheduler receives a few types of information for the range server. First, when a range server 400 receives a query, it submits a request for the appropriate storage servers 410a-410c to the scheduler 440. The scheduler 440 is also provided the respective flow control parameter (e.g., the server-allocation value) associated with each query. When range server 400 completes a particular sub-range query, it notifies the scheduler 440. The scheduler 440 sends information to range server 400, telling them to process a particular sub-range in a particular query next. Additional details related to the features of this system can be found in U.S. patent application Ser. No. 12/241,765, filed Sep. 30, 2008, and entitled “Parallel Execution of Range Query.” This application is incorporated herein by reference in its entirety.

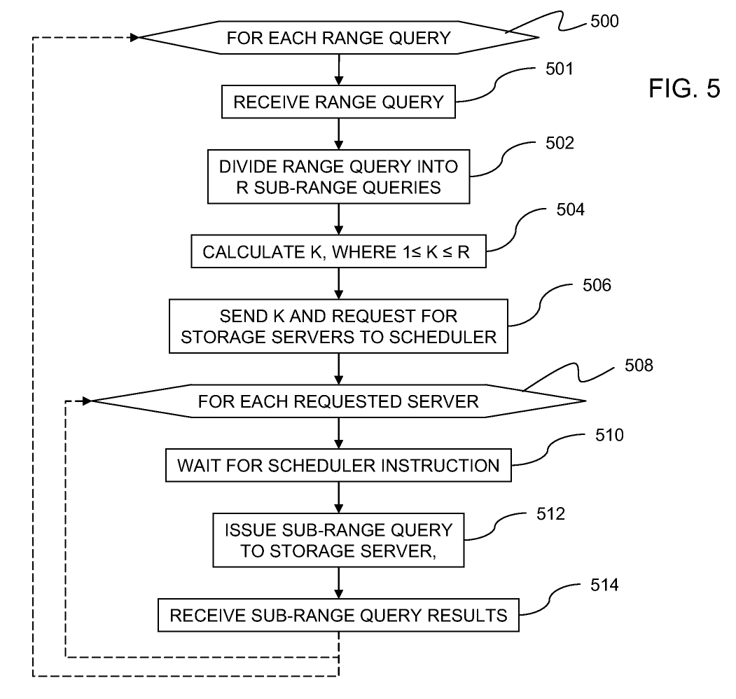

The operation of the range server 400 is similar to that described above with reference to FIG. 2, with the addition of coordination with scheduler 440. FIG. 5 shows an embodiment that related to operation of the range server 400. For each range query 500 a loop including the subsequent steps 501-514 is performed. One of ordinary skill will understand that the various instantiations of the loop of these steps 501-514 can execute concurrently. The range server 400 does not wait for completion of the first range query to begin processing the second range query.

At the next step 501, the range server 400 receives a range query from a requester (e.g., a client 430a.) The range query requests a range of sequential items in a database that is distributed among the storage devices or partitions 420a-420d. At the next step 502, the range server 400 divides the range query into R sub-range queries, where R is an integer. Each sub-range query corresponds to a respective portion of the range of sequential items stored in a respective storage device or partition 420a-420d. At the next step 504, the range server 400 determines the current value of the server-allocation value (denoted as k) for the query, where the server-allocation value is updated 210 as described above. At the next step 506, the range server 400 sends the value k and a request for the desired storage servers (i.e., those having access to the tablets that satisfy the range query). At the next step 508, a loop including previously described steps 510-514 is performed for each requested storage server. One of ordinary skill will understand that any or all of the various instantiations of the loop for these steps 510-514 can be performed concurrently. At the next step 510, the range server 400 waits until it receives an instruction from the scheduler 440 to request a tablet from the storage server having access to one of the tablets. At the next step 512, the range server 400 issues the sub-range queries to the particular storage server 410a-410c corresponding to the instruction from the scheduler 440. At the next step 514, the storage server 410a-410c receives at least one respective portion of the range of sequential items in the sub-range query results from the storage servers associated with the instruction from scheduler 440 and passes them on to the requester (the client 430a).

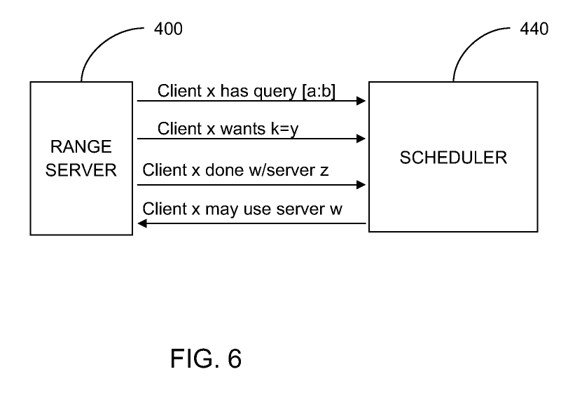

FIG. 6 shows a data flow diagram of the messages exchanged between an exemplary range server 400 and an exemplary scheduler 440. The first message indicates that client x has a query [a:b]. In some embodiments, this request includes a list of the specific servers that have access to the sub-ranges of the query [a:b]. The second message indicates the value of k, indicating the number y of storage servers 410a-410c that the range server 400 is currently requesting for the query [a:b]. The second message is kept separate from the definition of the range of query [a:b], so that the range server 400 can update its number of requested storage servers for the same query. The third message is sent to the scheduler when one of the sub-ranges completes transmission. In general, if two distinct, non-consecutive partitions (e.g., the second and third storage devices 420b, 420c) are accessed by the same storage server (e.g., the second server 410b), then the range server 400 sends the third message at the completion of each sub-range, relinquishing that storage server 410b after receiving the first sub-range, and waiting for another instruction from the scheduler before requesting the next sub-range 420c from the same storage server 410b. The fourth message is sent by scheduler 440, instructing range server 400 when a given client is permitted to access one of the requested storage servers.

Depending on the operational setting, one or more schedulers 440 may be provided. Some embodiments include plural schedulers 440, which may use a gossip protocol so each scheduler 440 can maintain a complete list of all ongoing queries. The scheduler service 440 is responsible for performing multi-query optimization in the system by minimizing contention on storage servers 410a-410c and balancing loads. The scheduler 440 is notified by the range server 400 regarding what storage servers 410a-410c need to be used by the queries, and how often. The scheduler 440 then determines which query should use which storage servers 410a-410c and when. The scheduler 440 executes a scheduling algorithm based on fairness. Consider a workload consisting of many short jobs which are interactive and expect to get results fast, and long jobs which can linger in the background, but should ideally get some initial results fast. It is preferable that the scheduling algorithm does not starve jobs, or impose too long idle periods on the queries in the sense that should make steady (rather than bursty) progress.

The scheduler 440 determines when to notify range server 400 that a given query may process a sub-range and determines which server can be assigned to the given query next. Preferably, the scheduler 440 does not schedule multiple sub-ranges on the same storage server 410a-410c at the same time. If multiple sub-range queries are scheduled in parallel on the same storage server 410a-410c, the two queries would contend for disk, providing worse throughput than if they were done one-at-a-time (an exception is the case in which two queries require very similar sub-ranges). Preferably, the scheduler 440 does not schedule a sub-range for a query such that it pushes the number of storage servers concurrently assigned to that query over the flow control k value.

The scheduler may employ a variety of methods for prioritizing queries for execution. In some embodiments, a FIFO (first in, first out) scheduler prioritizes queries based on order of arrival. This means that given a free storage server 410a-410c, the scheduler 440 finds the earliest query that (a) has a sub-range accessible by that storage server and (b) is currently assigned a number of storage servers smaller than the respective k value for that query. In other embodiments, the scheduler 440 uses a scheduling metric, called size-weighted round robin, that is designed to be fair in terms of giving each query a steady flow of results, but with the added ability to prioritize short queries over long queries (or even vice-versa). Depending on the operational setting, short jobs often correspond to end user requests that must see results quickly, while longer jobs more often can be done in the background (i.e. no one is immediately looking at the results). The size-weighted round robin scheduling metric can be used to control the amount of favoritism given to short jobs. By adjusting a tuning parameter, the user can configure the scheduler 440 to prefer a new short query to an existing long query that has not been granted a storage server 410a-410c for a long time, or the scheduler 440 can be configured to use length as a tiebreaker between two queries that have been waiting for equal amounts of time. Additional details can be found in U.S. patent application Ser. No. 12/241,765.

The scheduler 440 can be extended further to make use of cache and locality of queries. For instance, if multiple queries need results from the very same tablet, they should ideally be merged to optimize the performance of the system. Similarly, if it is known that some queries have recently been made to a particular tablet, it is likely that the pages are still being cached. In some embodiments, the scheduler takes this into account and directs the range server 400 to consult that storage server 410a before others. In such embodiments, the system keeps track of more state information, such as load of the storage servers 410a-410c, tablets recently visited, and the like, in order to be able to perform optimization based on these variables.

In some embodiments (particularly in those concurrently servicing multiple queries having both large and small query sizes), the range server 400 may return the sub-ranges in an arbitrary order, in which case the client 430a is responsible for ordering the sub-ranges. Implementing the following alternative approach would allow clients who wish to receive the results in order, at possible performance cost.

Since data from within each tablet typically arrive in the order sent, if the range server 400 visits the tablets approximately in order the results are returned in order. Firstly, the range server 400 may need to buffer up data in the client library. Ideally, the buffer of the range server 400 does not fill up quicker than the client 430a can retrieve data, so the flow control mechanism can be adapted so that the client library download rate to the range server 400 is proportional to how fast the client is absorbing data in the sorted order. Secondly, the order in which the storage servers 410a-410c are visited should be biased towards being as close to the sorted order as possible. Thirdly, when the range server 400 receives results from multiple storage servers 410a-410c (for larger k), it becomes possible to put them in buckets according to what part of the range they cover (according to the Client Range List). If the range server 400 retrieves a result that is in the front of the Range List, i.e. the smallest key that the range server 400 hasn't visited yet, then that can be returned to the user by the client library. Otherwise, the range server 400 buffers the result.

The scheduler 440 can make use of the hint that it receives about the query having to traverse tablets in order. When considering a future schedule, it in fact knows what servers need to be visited by the sorted query, and so the sorted query can be considered equivalent to a query that only needs to access one particular storage server 410a and give that query a preference over another query that can use any available storage server.

Should the scheduler stop functioning, some embodiments of the range server 400 are able to recover by falling back to its own internal fallback scheduler 401. One way to alleviate this problem is to reduce k to a small number, and fall back to a built-in fallback scheduler 401 that attempts to schedule storage the servers 410a-410c at random. If the scheduler 440 comes back up, the range server 400 should reveal the current state of the query and allow the scheduler 440 to again take over. The fallback scheduler 401 then remains dormant until the scheduler 440 again becomes unavailable.

Another alternative is to have the scheduler 440 plan ahead of time the order of which the storage servers 410a-410c should be visited during a scheduler outage, and provide this information to the range server 400. Then the fall-back scheduler 401 will have a good “evacuation route” in case the scheduler 440 goes down, since this route is guaranteed to respect the schedules of other queries. The scheduler 440 still reserves the right to change the schedule at any given point, and in fact remains the primary source for notifying the range server 400 regarding what the storage servers 410a-410c they should be visiting.

Each range server 400 can run a number of range server processes, but in many operation settings there is a single local scheduler 440 responsible for planning the query destinations for each of these processes. As things scale up, there will be multiple range servers, and it may not be scalable or feasible for all of them to communicate to the same scheduler.

When there are multiple schedulers, it would be highly beneficial if they could notify one another about the plans that they are making for the same storage servers. A simple way to do this that each scheduler connects to all other schedulers, and that they send notifications about the queries they are planning. The frequency at which they send queries determines the quality of the schedules, but includes a natural performance trade-off. It is not particularly important that all schedulers know about the desires of short queries, but longer running queries, which touch more servers and tablets, could easily become a performance bottleneck if schedulers are oblivious to their effects.

One way of minimizing communication overhead would be to use a gossip protocol, and send gossip messages only about “long” queries, which is deliberately left vague. In an exchange gossip protocol nodes pick a neighbor at random at some frequency, connect to that neighbor and compare the knowledge of current queries with that neighbor. If that neighbor has not heard about the long query running on one server 110c, the range server 100 tells that neighbor about it, and instead gets information about two long queries running on other servers 100a, 100b. The biggest benefit of gossip is the fixed bandwidth consumption, which offers scalability in the setting at which the distributed database is deployed, at the cost of slower data dissemination rates.

In some alternative embodiments, the model for the scheduling algorithms is extended to include weights on the tablets, where a weight is simply a scalar denoting how large the tablet is relative to the maximum tablet size. For instance, the time taken to run a query (with k=1) is proportional to the sum of the weights of the tablets it needs to touch.

The exemplary architectures described herein exploit the parallelism in the system to answer range queries faster than if done sequentially. The flow control in the range server 400 tunes the degree of parallelism with which a query is processed, based on the ability of the client 430a-430c to receive the results. The scheduler 440 ensures that multiple queries do not contend for the same storage server 410a-410c simultaneously, and enacts policies to control the relative priorities of the different queries.

Table 1 below illustrates a specific example of a range query where device/server labels from FIG. 1 have been used although this example also applies to the system in FIG. 4 with corresponding device/server labels. Assume a client 430a wishes to search an ordered table to find the results from the range 1500-4200 that match a predicate P. The client 430a issues this query, which is directed to the range server 400. The range server 400, a router that is equipped to handle range queries, now proceeds to determine what storage servers 410a-410c contain the range of data requested by the query. The range server 400 looks up 1500 in its interval map, determines that the tablet boundaries of the value 1500 are 1001-2000, and finds higher ranges until it finds 4200. Assume the tablets are arranged as follows.

TABLE 1

| Tablet Range | Device | Server |
|---|---|---|
| 1001-2000 | 120a | server 110a |
| 2001-3000 | 120b | server 110b |
| 3001-4000 | 120c | server 110b |
| 4001-5000 | 120d | server 110c |

The range server 400 now populates a list of the ranges it is to try, separated by tablet boundaries. In this case, the list L would be 1200-2000, 2001-3000, 3001-4000, 4001-4200. This is done by consulting an Interval Map (IMAP) that is generated by a router process running on the range server 400.

The next step is to send the results off to the storage servers 410a-410c to retrieve the data from the storage device units 420a-420d. There are two determinations to be made: (a) How many storage servers 410a-410c should be asked to retrieve data in parallel? (b) In what order should the storage servers 410a-410c be visited?

The range server 400 addresses the first question by means of the flow control mechanism shown in FIG. 2. The answer to the second question is straightforward in the case of FIG. 1, where only a single query is being serviced by a single range server 100. If the range server 100 is only servicing a single query from one client 130, as shown in FIG. 1, then the storage servers 110a-110c are visited according to the order of the tablets to be returned. In the example of Table 1 above, the tablets with data in the ranges 1500-2000, 2001-3000, 3001-4000 and 4001-4200 are stored in respective storage devices 120a, 120b, 120c, and 120d, which are accessible by storage servers 110a, 110b, 110b and 110c, respectively. Therefore, the range server 100 requests data from the storage servers 110a, 110b and 110c in that order. In the example of only a single query, the range server 100 may issue two requests to storage server 110b for the data in 2001-3000 and 3001-4000, respectively, or the range server 100 may issue a single query for the range 2001-4000. Because there is no contention with any other query, the result is essentially the same.

However, if the range server 400 is being queried by multiple clients (as discussed above with reference to FIG. 4, the second question is addressed by consulting the scheduler 440 whose purpose is to optimize accesses of storage servers 410a-410c by multiple queries with respect to performance. Although the scheduler 440 is shown in FIG. 4 as being a separate processor from the range server 400, in alternative embodiments, the scheduler 440 and range server 400 may be hosted in the same computer.

Referring again to FIG. 4, the range server 400 notifies the scheduler 440 via socket that it has received a query that touches servers once 410a, 410b, 410c or twice 410b. The range server now enters a processing loop. This loops polls a scheduler socket along with all other sockets to the storage servers 410a-410c for data. A response to the scheduling notification tells the range server 400 to connect to a server 410a. This causes the range server 400 to connect to that server 410a via an interface that is polled in the loop.

A query arrives at the storage server 410a requesting the range 1200:2000. The storage unit 410a recognizes that the special character means that the range query code should be used. It asks the data store (which may be, for example, a B-tree or a database management system, DBMS, e.g., “MYSQL” from MySQL AB of Sweden) about the results, installs a callback handler and then exits. The callback handler is responsible for retrieving results from the DBMS one at a time, and immediately flush them to the range server 400. The storage server 410a also reports how fast it is sending results (e.g., as number of bytes/millisecond), either explicitly, or inherently through the communications protocol between the range server 400 and the storage server 410a.

Meanwhile, the range server 400, as a part of an ongoing polling loop, tries to match the reception rate by the client 430a and the aggregate server transmission rate. A flow control module of the range server 400 performs this function.

The flow control module start by allowing k=1 servers to be probed in parallel. In some embodiments, the range server 100 implements flow control by dynamically modifying the number of concurrent requests k, and so it increases or decreases the value of k according to the updating process 210 shown in FIG. 2 where server-allocation value is identified with k. When k changes, the range server 400 notifies the scheduler 440 so the scheduler 440 can notify the range server 400 to connect to new storage servers 410a-410c. In some embodiments, when k is decreased, the range server 400 does not disconnect from the storage servers 410a-410c that are servicing the query. Rather, the range server 400 relies on the fact that if the client 430a is too slow at receiving messages, the blocking writes and flushes are going to allow the storage server 410a and the range server 400 to sleep while waiting for data to be picked up by the client 430a, and so the corresponding machines can switch context to other processes or queries. In other embodiments, to avoid any reduction in performance due to the storage server 410a sleeping when a client 430a is slow, the scheduler 440 learns when the storage server 410a is not currently scanning any tablets. Then the storage server 440 can schedule another query on that storage server 410a.

When the range server 400 receives data from a storage server 410a-410c, a write-back handler (not shown) will check if there is an entire record to be found in the current data buffer, and if so, flush it to the client 430a. This causes the records to arrive in an arbitrary order back at the client side, in a first-in first-out (FIFO) basis. The complete set of records arrives as a large JavaScript Object Notation (JSON) object at the client 430a, and an incremental JSON parser in the client library is responsible for detecting when a new record is available rather than waiting for the whole structure to buffer up.

When a result is received from the storage server 410a, the range server 400 ticks off the list of ranges corresponding to the sub-ranges that are known to have been scanned. Assume the first record from a server 410a had primary key 1216. The range server 400 knows that all keys between and including 1200 and 1216 have been scanned. Consequently, the range server 400 modifies its list of remaining ranges L to be 1216-2000, 2000-3000, 3000-4000, 4000-4200. This means that, if the storage server 410a fails during transmission, the range server 400 can resend the request to a different storage server 410b, 410c (possibly located in a different region) containing the 1000-2000 tablet from table, and the range server 400 knows exactly where to pick up without having to notify the client 430a of the failure.

When a request is finalized from the storage server 410a, the range server 400 ticks off all of the remaining ranges that that the storage server 410a was working on. In this case, upon receiving record 1992 and then having the server 410a disconnect, the range server 400 knows that all of sub-range 1200-2000 has been scanned, but the range server 400 is careful not to tick off any other ranges belonging to that server.

At least some values for the results of the above-describe methods can be output to a user or saved for subsequent use. For example the results of a range request can be saved directly at the requesting client. Alternatively, some derivative or summary form of the results (e.g., averages, interpolations, etc.) can be saved for later use according to the requirements of the operational setting.

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus or computer may be configured as a system that includes one or more units, each of which is configured to carry out some aspects of the method either in software, in hardware or in some combination thereof. For example, the system may be configured as part of a computer network that includes the Internet. At least some values for the results of the method can be saved for later use in a computer-readable medium, including memory units (e.g., RAM (Random Access Memory), ROM (Read Only Memory)) and storage devices (e.g., hard-disk systems, optical storage systems).

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII). In some contexts, a computer-readable medium may be alternatively described as a computer-useable medium, a computer-storage medium, or a computer-program medium. Depending on the on the operational setting, specified values for the above-described methods may correspond to input files for the computer program or computer.

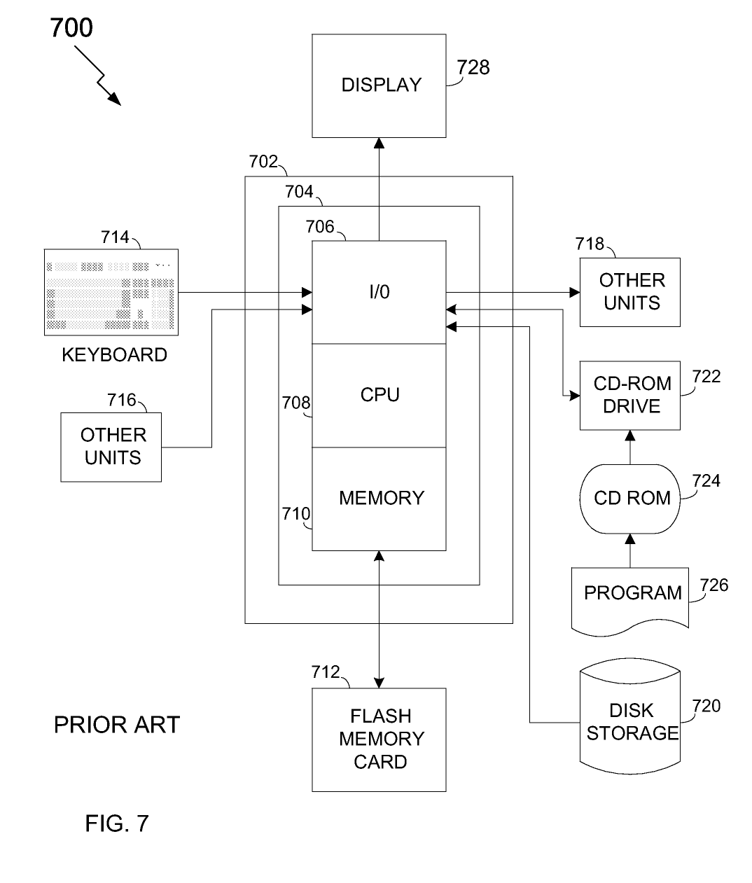

As described above, certain embodiments of the present invention can be implemented using standard computers and networks including the Internet. FIG. 7 shows a conventional general purpose computer 700 with a number of standard components. The main system 702 includes a motherboard 704 having an input/output (I/O) section 706, one or more central processing units (CPU) 708, and a memory section 710, which may have a flash memory card 712 related to it. The I/O section 706 is connected to a display 728, a keyboard 714, other similar general-purpose computer units 716, 718, a disk storage unit 720 and a CD-ROM drive unit 722. The CD-ROM drive unit 722 can read a CD-ROM medium 724 which typically contains programs 726 and other data.

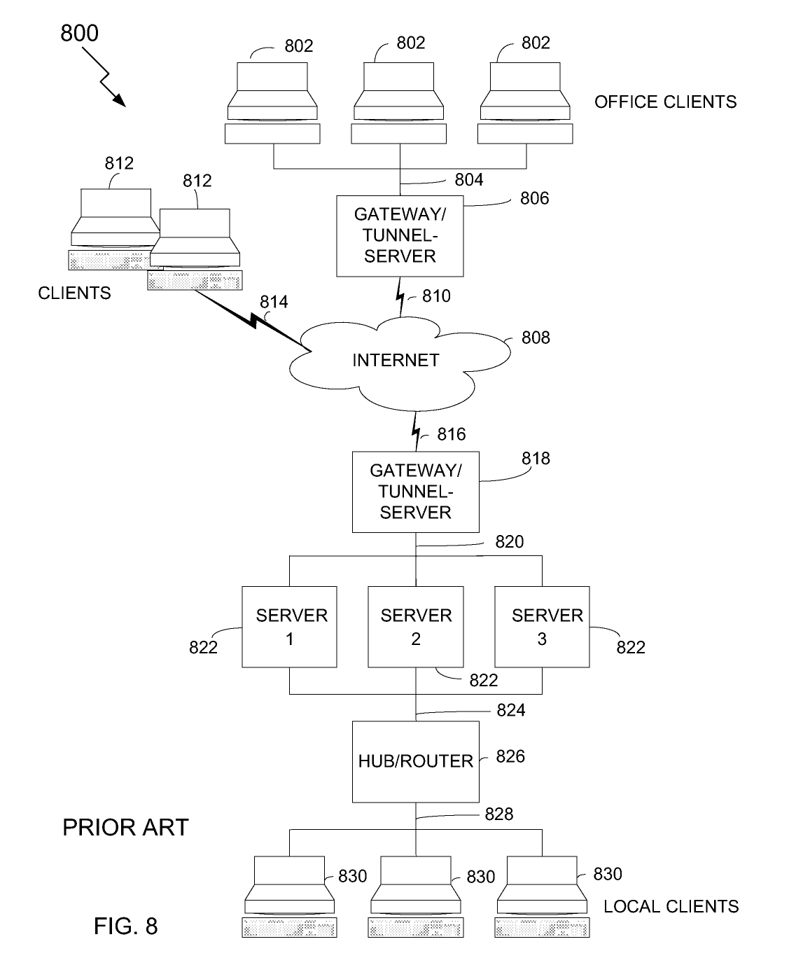

FIG. 8 shows a conventional Internet network configuration 800, where a number of office client machines 802, possibly in a branch office of an enterprise, are shown connected 804 to a gateway/tunnel-server 806 which is itself connected to the Internet 808 via some internet service provider (ISP) connection 810. Also shown are other possible clients 812 similarly connected to the Internet 808 via an ISP connection 814. An additional client configuration is shown for local clients 830 (e.g., in a home office). An ISP connection 816 connects the Internet 808 to a gateway/tunnel-server 818 that is connected 820 to various enterprise application servers 822. These servers 822 are connected 824 to a hub/router 826 that is connected 828 to various local clients 830.

Although only certain exemplary embodiments of this invention have been described in detail above, those skilled in the art w-ill readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method of allocating servers for range requests, comprising:
receiving a range request for items in a database that is distributed across a plurality of storage devices that are accessible through corresponding servers in a network that includes the storage devices and the servers;
initializing a server-allocation value for the range request, wherein the server-allocation value specifies a number of servers to allocate for executing the range request;
executing the range request by allocating the servers and using the allocated servers to provide values from the range request to a client that accesses the network; and
updating the server-allocation value while executing the range request to improve a consumption rate for the client by comparing changes in the consumption rate with changes in the number of allocated servers.

2. A method according to claim 1, wherein the range request corresponds to a sequence defined by an index, and the method further comprises: partitioning the sequence for the range request into sub-sequences for corresponding storage devices where separate portions of the sequence are stored.

3. A method according to claim 1, wherein allocating the servers includes: allocating an additional server when the server-allocation value is increased or when the server-allocation value is maintained and a given server reaches a termination condition for providing range-request values from a given storage device to the client.

4. A method according to claim 1, wherein allocating the servers includes: allocating no additional server when the server-allocation value is decreased and a given server reaches a termination condition for providing range-request values from a given storage device to the client.

5. A method according to claim 1, wherein updating the server-allocation value includes: increasing the server-allocation value while measuring the consumption rate until a termination condition for increasing the server-allocation value is reached, wherein the termination condition for increasing the server-allocation value includes a non-increasing consumption rate.

6. A method according to claim 1, wherein updating the server-allocation value includes: decreasing the server-allocation value while measuring the consumption rate until a termination condition for decreasing the server-allocation value is reached, wherein the termination condition for decreasing the server-allocation value includes a decreasing consumption rate.

7. A method according to claim 1, wherein updating the server-allocation value includes randomizing a choice for increasing, decreasing, or maintaining the server-allocation value, wherein
increasing the server-allocation value includes increasing the server-allocation value while measuring the consumption rate until a termination condition for increasing the server-allocation value is reached, wherein the termination condition for increasing the server-allocation value includes a non-increasing consumption rate, and
decreasing the server-allocation value includes decreasing the server-allocation value while measuring the consumption rate until a termination condition for decreasing the server-allocation value is reached, wherein the termination condition for decreasing the server-allocation value includes a decreasing consumption rate.

8. A computer-readable medium that stores a computer program for allocating servers for range requests, wherein the computer program includes instructions for:
receiving a range request for items in a database that is distributed across a plurality of storage devices that are accessible through corresponding servers in a network that includes the storage devices and the servers;
initializing a server-allocation value for the range request, wherein the server-allocation value specifies a number of servers to allocate for executing the range request;
executing the range request by allocating the servers and using the allocated servers to provide values from the range request to a client that accesses the network; and
updating the server-allocation value while executing the range request to improve a consumption rate for the client by comparing changes in the consumption rate with changes in the number of allocated servers.

9. A computer-readable medium according to claim 8, wherein the range request corresponds to a sequence defined by an index, and the computer program further includes instructions for: partitioning the sequence for the range request into sub-sequences for corresponding storage devices where separate portions of the sequence are stored.

10. A computer-readable medium according to claim 8, wherein allocating the servers includes: allocating an additional server when the server-allocation value is increased or when the server-allocation value is maintained and a given server reaches a termination condition for providing range-request values from a given storage device to the client.

11. A computer-readable medium according to claim 8, wherein allocating the servers includes: allocating no additional server when the server-allocation value is decreased and a given server reaches a termination condition for providing range-request values from a given storage device to the client.

12. A computer-readable medium according to claim 8, wherein updating the server-allocation value includes: increasing the server-allocation value while measuring the consumption rate until a termination condition for increasing the server-allocation value is reached, wherein the termination condition for increasing the server-allocation value includes a non-increasing consumption rate.

13. A computer-readable medium according to claim 8, wherein updating the server-allocation value includes: decreasing the server-allocation value while measuring the consumption rate until a termination condition for decreasing the server-allocation value is reached, wherein the termination condition for decreasing the server-allocation value includes a decreasing consumption rate.

14. A computer-readable medium according to claim 8, wherein updating the server-allocation value includes randomizing a choice for increasing, decreasing, or maintaining the server-allocation value, wherein
increasing the server-allocation value includes increasing the server-allocation value while measuring the consumption rate until a termination condition for increasing the server-allocation value is reached, wherein the termination condition for increasing the server-allocation value includes a non-increasing consumption rate, and
decreasing the server-allocation value includes decreasing the server-allocation value while measuring the consumption rate until a termination condition for decreasing the server-allocation value is reached, wherein the termination condition for decreasing the server-allocation value includes a decreasing consumption rate.

15. An apparatus for allocating servers for range requests, the apparatus comprising a computer for executing computer instructions, wherein the computer includes computer instructions for:
receiving a range request for items in a database that is distributed across a plurality of storage devices that are accessible through corresponding servers in a network that includes the storage devices and the servers;
initializing a server-allocation value for the range request, wherein the server-allocation value specifies a number of servers to allocate for executing the range request;
executing the range request by allocating the servers and using the allocated servers to provide values from the range request to a client that accesses the network; and
updating the server-allocation value while executing the range request to improve a consumption rate for the client by comparing changes in the consumption rate with changes in the number of allocated servers.

16. An apparatus according to claim 15, wherein updating the server-allocation value includes: increasing the server-allocation value while measuring the consumption rate until a termination condition for increasing the server-allocation value is reached, wherein the termination condition for increasing the server-allocation value includes a non-increasing consumption rate.

17. An apparatus according to claim 15, wherein updating the server-allocation value includes: decreasing the server-allocation value while measuring the consumption rate until a termination condition for decreasing the server-allocation value is reached, wherein the termination condition for decreasing the server-allocation value includes a decreasing consumption rate.

18. An apparatus according to claim 15, wherein updating the server-allocation value includes randomizing a choice for increasing, decreasing, or maintaining the server-allocation value, wherein
increasing the server-allocation value includes increasing the server-allocation value while measuring the consumption rate until a termination condition for increasing the server-allocation value is reached, wherein the termination condition for increasing the server-allocation value includes a non-increasing consumption rate, and
decreasing the server-allocation value includes decreasing the server-allocation value while measuring the consumption rate until a termination condition for decreasing the server-allocation value is reached, wherein the termination condition for decreasing the server-allocation value includes a decreasing consumption rate.

19. An apparatus according to claim 15, wherein the computer includes a processor with memory for executing at least some of the computer instructions.

20. An apparatus according to claim 15, wherein the computer includes circuitry for executing at least some of the computer instructions.
